(19) United States
(12) Patent Application Publication
(10) Pub. No.: US 2023/0329298 A1
(43) Pub. Date: Oct. 19, 2023

(54) METHOD FOR PRODUCING A SAVOURY FLAVOUR BY FERMENTATION OF ONION OR GARLIC

(71) Applicant: UNIVERSITAET HOHENHEIM, Stuttgart (DE)

(72) Inventors: Marina RIGLING, Stuttgart (DE); Yanyan ZHANG, Stuttgart (DE)

(21) Appl. No.: 18/026,033

(22) PCT Filed: Sep. 10, 2021
(86) PCT No.: PCT/EP2021/074908

§ 371 Date: Mar. 13, 2023

(30) Foreign Application Priority Data
Sep. 14, 2020 (DE) 10 2020 123 866.5

(51) Int. Cl. A23L 27/10; A23L 13/40; A01G 18/20

(52) U.S. Cl. CPC A23L 27/105; A23L 13/428; A01G 18/20

(57) ABSTRACT

The invention relates to a method for preparing a solution which has a savory flavor, the method comprising the following steps: (a) providing a mycelium of a basidiomycete, (b) cultivating the mycelium in an aqueous culture liquid for a cultivation duration of 5 to 108 hours, wherein the culture liquid has at least one part of a plant of the genus Allium L., wherein by cultivating the mycelium a savory flavor is produced in the culture liquid, and (c) separating the culture liquid from the mycelium and the part of the plant, as a result of which the solution having the savory flavor is obtained, wherein the part of the plant is a clove of a garlic plant and the basidiomycete is Laetiporus sulphureus, Polyporus umbellatus, Pycnoporus cinnabarinus, Pleurotus ostreatus, Pleurotus sapidus and/or Trametes versicolor, or wherein the part of the plant is an onion from an onion plant and the basidiomycete is Laetiporus sulphureus, Polyporus umbellatus, Pycnoporus cinnabarinus, Pleurotus ostreatus, Lentinula edodes and/or Lepista nuda. The invention also relates to a solution obtainable by the method and to a use of the solution for flavoring foodstuffs.

### FIELD OF THE INVENTION

The invention relates to a method for preparing a solution which has a savory flavor. The invention further relates to a solution having a savory flavor obtainable by the method according to the invention. The invention further relates to a use of the solution for flavoring foodstuffs.

### BACKGROUND OF THE INVENTION

Vegetarian and vegan foodstuffs are increasingly in demand as more and more people want to avoid consuming animal products, especially meat and sausage, for health and/or environmental reasons. At the same time, many people like the typical savory taste of meat and sausage. There are therefore numerous vegetarian or vegan meat or sausage substitutes on the market which, in addition to their appearance and texture, are also based on the smell and taste of meat or sausage. However, the smell and taste experience of such products often cannot be compared with that of real meat or real sausage.

To imitate the smell and taste of meat or sausage, appropriate savory flavors can be added to the meat or sausage substitutes. These flavors are often artificially produced flavors. However, consumers are increasingly demanding that all foodstuff ingredients have a natural origin. For this reason, natural flavors are becoming increasingly important for the food industry.

Biotechnological methods for producing natural flavors using bacteria, yeasts or fungi are known for certain natural flavors. For example, cultivating certain strains of mushrooms can produce flavors that taste like peach or coconut. However, to date, there is no method by which a natural savory flavor can be obtained.

Therefore, there is a need for a method for producing a savory flavor which has a natural origin and can be used to flavor foodstuffs, especially vegetarian and vegan foodstuffs.

### SUMMARY OF THE INVENTION

The present invention relates to a method for preparing a solution which has a savory flavor, the method comprising the following steps:
(a) providing a mycelium of a basidiomycete,
(b) cultivating the mycelium in an aqueous culture liquid for a cultivation duration of 5 to 108 hours, wherein the culture liquid has at least a part of a plant of the genus Allium L., wherein by cultivating the mycelium a savory flavor is produced in the culture liquid, and
(c) separating the culture liquid from the mycelium and the part of the plant, as a result of which the solution having the savory flavor is obtained, wherein the part of the plant is a clove of a garlic plant and the basidiomycete is Laetiporus sulphureus, Polyporus umbellatus, Pycnoporus cinnabarinus, Pleurotus ostreatus, Pleurotus sapidus and/or Trametes versicolor, or wherein the part of the plant is a bulb from an onion plant and the basidiomycete is Laetiporus sulphureus, Polyporus umbellatus, Pycnoporus cinnabarinus, Pleurotus ostreatus, Lentinula edodes and/or Lepista nuda.

The invention further relates to a solution having a savory flavor obtainable by a method according to the invention.

The invention further relates to a use of the solution according to the invention for flavoring foodstuffs.

### BRIEF DESCRIPTION OF THE FIGURES

FIG. 1 shows a gas chromatogram of extracted flavoring substances from a sample of a culture liquid containing a clove of a garlic plant. No mycelium was cultivated in the culture liquid (control without mycelium). The compounds already identified are: 1: diallyl sulphide; 2: diallyl disulphide; 3: methyl propyl trisulphide; 4: allyl trisulphide.

FIG. 2 shows a gas chromatogram of extracted flavoring substances from a sample of a culture liquid containing a clove of a garlic plant. A mycelium of Laetiporus sulphureus was cultivated in the culture liquid. The compounds already identified are: 2: diallyl disulphide; 5: benzothiazole; 6: eugenol.

FIG. 3 shows a gas chromatogram of extracted flavoring substances from a sample of a culture liquid containing a clove of a garlic plant. A mycelium of Polyporus umbellatus was cultivated in the culture liquid. The compounds already identified are: 2: diallyl disulphide; 6: eugenol; 7:5-sec-butyl-2,3-dimethylpyrazine.

### DETAILED DESCRIPTION OF THE INVENTION

In a first aspect, the invention relates to a method for preparing a solution which has a savory flavor, the method comprising the following steps:
(a) providing a mycelium of a basidiomycete,
(b) cultivating the mycelium in an aqueous culture liquid for a cultivation duration of 5 to 108 hours, wherein the culture liquid has at least a part of a plant of the genus Allium L., wherein by cultivating the mycelium a savory flavor is produced in the culture liquid, and
(c) separating the culture liquid from the mycelium and the part of the plant, as a result of which the solution having the savory flavor is obtained, wherein the part of the plant is a clove of a garlic plant and the basidiomycete is Laetiporus sulphureus, Polyporus umbellatus, Pycnoporus cinnabarinus, Pleurotus ostreatus, Pleurotus sapidus and/or Trametes versicolor, or wherein the part of the plant is a bulb from an onion plant and the basidiomycete is Laetiporus sulphureus, Polyporus umbellatus, Pycnoporus cinnabarinus, Pleurotus ostreatus, Lentinula edodes and/or Lepista nuda.

By means of the method according to the invention, the solution which has the savory flavor is prepared. The method is particularly suitable for providing a savory flavor for the food industry.

The term “flavor” as used herein means a specific odor and/or taste. The flavor comes from a flavoring substance or a mixture of flavoring substances. The inventors assume that the flavor produced in the method according to the invention is composed of a plurality of flavoring substances, i.e. it is produced by a mixture of flavoring substances.

The term “savory flavor” as used herein refers to a flavor that is also perceived by humans as hearty, substantial, strong and/or nutritious. The savory flavor is a flavor that is not perceived as fruity, for example. The savory flavor can be, for example, a meat flavor and/or a sausage flavor.

The inventors have surprisingly found that when certain basidiomycetes are cultivated with certain parts of the plant, a savory flavor, particularly a savory meat-like or sausage-like flavor, is produced in the culture liquid. The flavor has a high intensity. The exact nature of the resulting flavor depends on the basidiomycete and the part of the plant.

The savory flavor produced by means of the method according to the invention is a natural flavor. The term “natural flavor” as used herein means a flavor that has a natural origin. The method according to the invention is a biotechnological method in which the natural savory flavor is obtained from plant starting materials (substrates) with the aid of certain fungal strains. The savory flavor can be used to flavor foodstuffs. The savory flavor can advantageously be used in vegetarian and vegan foodstuffs, since no animal ingredients are used in the method according to the invention.

The method according to the invention is fast, simple, and cost-effective. The plant starting materials are available in large quantities and cost-effectively.

For the method according to the invention, the mycelium of the basidiomycete is first provided. Basidiomycetes, also known as basidiomycota or stand fungi, are a division of fungi belonging to the Dikarya subkingdom in the kingdom of fungi. Their mycelium consists of microscopically fine, filamentous hyphae. The basidiomycetes that can be used for the method according to the invention are basidiomycetes that are edible for humans. The basidiomycetes have GRAS status under food law, which means that they are generally recognized as safe (“Generally Recognized as Safe”) and are therefore harmless.

The mycelium of the basidiomycete is cultivated in the culture liquid. The cultivation is a typical submerged cultivation, which means that the mycelium is distributed in the culture liquid.

The cultivation of the mycelium takes place under aerobic conditions. Cultivation typically takes place with shaking or stirring in shake flasks or bioreactors. Shaking or stirring introduces oxygen into the culture liquid. If necessary, cultivation can also be performed with the introduction of air or oxygen. The cultivation of the mycelium can also be referred to as fermentation.

The culture liquid is aqueous and has at least one part of the plant of the genus Allium L. The culture liquid can also be referred to as the medium or production medium. The part of the plant serves as a substrate for the mycelium. The part of the plant is the clove of a garlic plant (Allium sativum L.), hereinafter also referred to as garlic clove, or the bulb from an onion plant (Allium cepa L.).

The term “garlic plant” as used herein means a plant of the plant species garlic (Allium sativum L.). The term “clove” as used herein refers to a specific part of the garlic plant, namely a part of the underground storage organ of the garlic plant. The storage organ, also called a garlic bulb, has several cloves. For the method according to the invention, a part of a clove, one or more cloves up to a plurality of cloves can be used. This depends on the size of the cloves, the volume of the culture liquid and the proportion of cloves in the culture liquid. The clove can be used fresh, dried or, in case of previous freezing, thawed. Preferably, the clove is used thawed. The clove can be used with or without the skin. Preferably, the clove is used without the skin.

The term “onion plant” as used herein means a plant of the plant species onion (Allium cepa L.), also called edible onion or common onion. In contrast, the term “bulb” as used herein refers to a specific part of the onion plant, namely, the underground storage organ of the onion plant. For the method according to the invention, a part of a bulb, one or more bulbs up to a plurality of bulbs can be used. This depends on the size of the bulbs, the volume of the culture liquid and the proportion of bulbs in the culture liquid. The bulb can be used fresh, dried or, in case of previous freezing, thawed. Preferably, the bulb is used fresh. Preferably, the bulb is a yellow bulb. The bulb can be used with or without the skin. Preferably, the bulb is used without the skin.

The mycelium is cultivated in the culture liquid for a cultivation duration of 5 to 108 hours. The inventors have found that a cultivation duration of less than 5 hours is not sufficient to preserve the savory flavor. The mycelium needs some time to adapt to the substrate and to change its metabolism accordingly.

In addition, the inventors have found that, when exceeding a cultivation duration of 108 hours, an unpleasant odor such as a urine-like, fetid and/or musty odor may develop instead of the savory flavor.

When the clove of a garlic plant is used, the basidiomycete is Laetiporus sulphureus, Polyporus umbellatus, Pycnoporus cinnabarinus, Pleurotus ostreatus, Pleurotus sapidus, and/or Trametes versicolor.

When the bulb from an onion plant is used, the basidiomycete is Laetiporus sulphureus, Polyporus umbellatus, Pycnoporus cinnabarinus, Pleurotus ostreatus, Lentinula edodes, and/or Lepista nuda.

The fungal species that can be used in the method according to the invention belong to the class of Agaricomycetes. In a preferred embodiment, only one single fungal species is used. However, it is also conceivable to cultivate two or more species of mushrooms together.

Most of the fungal species that can be used in the method according to the invention are deposited at the Leibniz Institute German Collection of Microorganisms and Cell Cultures (DSMZ) located in Braunschweig, Germany. The deposit numbers (DSM No.), if available, are given below:

| | |
|---|---|
| Laetiporus sulphureus | DSM No. 1014 |
| Pleurotus ostreatus | DSM No. 1020 |
| Polyporus umbellatus | not deposited in DSMZ |
| Pycnoporus cinnabarinus | DSM No. 1184 |
| Pleurotus sapidus | DSM No. 8266 |
| Trametes versicolor | DSM No. 1977 |
| Lentinula edodes | DSM No. 3565 |
| Lepista nuda | DSM No. 8620 |

After cultivating the mycelium, the culture liquid is separated from the mycelium and the part of the plant. This step can also be referred to as clarifying the culture liquid. This preserves the solution which has the savory flavor. The solution which has the savory flavor corresponds to the culture liquid freed from the substrate (part of the plant) and the mycelium. Therefore, the solution obtained in the step (c) is an aqueous solution. The solution can be used directly as a flavor.

The part of the plant that is still present in the culture liquid after cultivating the mycelium can also be referred to as the residue.

Separating the culture liquid from the mycelium and the part of the plant can be done, for example, by filtration or by centrifugation.

By separating the culture liquid from the mycelium and the part of the plant, the cultivation of the mycelium is also terminated. This ensures that the resulting savory flavor is preserved.

Cultivation may also be terminated prior to step (c) by other means, such as cooling the culture to 4° C., when the desired cultivation duration or flavor is achieved.

The method according to the invention is suitable for implementation on a large industrial scale.

In a preferred embodiment, step (b) is carried out in the absence of light. Cultivating the mycelium in step (b) can also take place under normal daylight, since daylight has little effect on flavor synthesis. Typically, however, the cultivation of the mycelium takes place in the absence of light, i.e. in the dark.

Cultivating the mycelium in step (b) can also take place under exposure to UV light. In the process, the inventors found that the savory flavor obtained when exposed to UV light can differ from the flavor obtained when the mycelium is cultivated without UV light.

In a preferred embodiment, the savory flavor is a meat flavor and/or a sausage flavor. The term “meat flavor” (also “meat-like flavor”) as used herein refers to a flavor that people generally associate with the foodstuff meat. The meat can be, for example, chicken, turkey, beef, veal, lamb, or pork. In particular, the meat flavor comprises flavors of forms of meat prepared for consumption, such as cooked, roasted, or fried meat. The meat flavor can be a flavor of cooked meat, for example. The term “meat flavor” as used herein also comprises the flavor of bacon.

The term “sausage flavor” (also “sausage-like flavor”) as used herein refers to a flavor that people generally associate with the foodstuff sausage. The sausage can be, for example, salami, ham, liver sausage, liver loaf, mettwurst, blood sausage, wiener, or bratwurst. The sausage flavor can be a flavor of salami, for example.

In a preferred embodiment, the flavor is an odor. The emergence of the odor in the culture liquid is particularly easy to detect.

In a preferred embodiment, the flavor is an odor and a taste. The inventors have found that the odor of the solution obtained by means of the method according to the invention corresponds very well to the taste of the solution. In particular, an intense meat-like and/or sausage-like taste could also be perceived in solutions having a meat-like and/or sausage-like odor.

In a preferred embodiment, the basidiomycete is Laetiporus sulphureus, Polyporus umbellatus, Pycnoporus cinnabarinus, and/or Pleurotus ostreatus. These basidiomycetes are preferred because they lead to a savory flavor with both the garlic clove and the bulb. Therefore, they can also be cultivated in a culture liquid containing a mixture of a clove of a garlic plant and a bulb from an onion plant. Accordingly, it is preferred that when the part of the plant is the clove of a garlic plant and the basidiomycete is Laetiporus sulphureus, Polyporus umbellatus, Pycnoporus cinnabarinus and/or Pleurotus ostreatus, the culture liquid further contains a bulb from an onion plant. Similarly, it is preferred that when the part of the plant is the bulb from an onion plant and the basidiomycete is Laetiporus sulphureus, Polyporus umbellatus, Pycnoporus cinnabarinus and/or Pleurotus ostreatus, the culture liquid further contains a clove of a garlic plant.

In a preferred embodiment, the part of the plant is the clove of a garlic plant and the basidiomycete is Polyporus umbellatus, or the part of the plant is the bulb from an onion plant and the basidiomycete is Polyporus umbellatus, Pycnoporus cinnabarinus, or Lentinula edodes. In these combinations of substrate and basidiomycete, the savory flavor produced in the culture liquid is a meat flavor.

The inventors have determined that the following flavoring substances, which are produced in the culture liquid, could play a role in the meat flavor: methyl-2-propenyl sulphide, 2-hexadecanol, γ-crotonolactone and 2-hydroxy-2-cyclopenten-1-one. The inventors assume that not only individual flavoring substances with a meat-like flavor are responsible for the overall meat-like flavor of the culture liquid. Instead, the inventors assume that a mixture of flavoring substances is responsible for the overall flavor. This is because various interactions occur between flavoring substances, resulting in a determined overall flavor. Typically, an overall flavor in the food sector is composed of 10 to 15 flavoring substances of different odors, which then interact to form the typical odor.

In a particularly preferred embodiment, the part of the plant is the bulb from an onion plant and the basidiomycete is Pycnoporus cinnabarinus. In this combination of substrate and basidiomycete, the meat flavor produced in the culture liquid is a bacon flavor.

In a preferred embodiment, the part of the plant is the clove of a garlic plant and the basidiomycete is Laetiporus sulphureus, Pycnoporus cinnabarinus or Pleurotus ostreatus, or the part of the plant is the bulb from an onion plant and the basidiomycete is Pleurotus ostreatus or Lepista nuda. In these combinations of substrate and basidiomycete, the savory flavor produced in the culture liquid is a sausage flavor.

In a particularly preferred embodiment, the part of the plant is the clove of a garlic plant and the basidiomycete is Laetiporus sulphureus. With this combination of substrate and basidiomycete, the sausage flavor produced in the culture liquid is a flavor of salami.

The inventors found that the flavoring substance methyl-2-propenyl disulphide could play a role in the flavor of salami. As described above for the meat flavor, it can also be assumed here that not just a single flavoring substance is responsible for the salami-like overall flavor. Rather, the inventors also assume here that the interaction of the flavoring substances in the mixture of flavoring substances leads to the overall flavor. Other flavoring substances with salami-like/meat-like flavors have already been identified.

In comparison with commercially available salami, the inventors were able to obtain hardly any matches in the flavoring substance profile. Nevertheless, the culture liquid from the cultivation of Laetiporus sulphureus with garlic clove as substrate and the commercially available salami showed a similar flavor.

In a preferred embodiment, the part of the plant is the bulb from an onion plant and the basidiomycete is Laetiporus sulphureus. This combination of substrate and basidiomycete produces a meat flavor and a sausage flavor in the culture liquid.

In a preferred embodiment, the part of the plant is in a minced shape, wherein the minced form is preferably a pressed, chopped, ground or pureed form. The minced form makes it easier for the basidiomycete to produce the savory flavor. The pressed form can be achieved, for example, by pressing (crushing) the part of the plant with a knife. The clove of the garlic plant is preferably in a pressed form. The bulb of the onion plant is preferably in a cut form.

In a preferred embodiment, the part of the plant has a proportion of 1% by weight to 5% by weight, more preferably 2% by weight, based on the total weight of the culture liquid. At 2% by weight, this means that the part of the plant in the culture liquid has a concentration of 20 g/L. At this concentration, the formation of the savory flavor in the culture liquid proceeds particularly well.

In a preferred embodiment, the culture liquid consists of water, preferably distilled water, and the part of the plant. Such a culture liquid is particularly quick and easy to prepare. It is also particularly cost-effective. The fungal species that can be used in the method according to the invention do not require any other substrate for their cultivation apart from the part of the plant. Thus, after separating the culture liquid from the mycelium and the part of the plant, a solution can be obtained consisting only of water, the flavor and possibly other metabolites of the fungi. Such a solution can be used in a particularly diverse manner and can be further processed in a variety of ways. Moreover, the formation of the savory flavor proceeds particularly well in a culture liquid consisting only of water and the part of the plant.

In another embodiment, the culture liquid contains other substances. The other substances are preferably growth substrates, i.e. substances that promote the growth of the mycelium. The addition of growth substrates can stimulate the growth of the mycelium to a greater extent and thus increase the formation of certain flavoring substances. The growth substrates are, for example, glucose, minerals, vitamins and/or precursors.

In a preferred embodiment, the culture liquid is sterilised prior to step (b). Sterilisation of the culture liquid can be done, for example, by autoclaving. Autoclaving is typically performed at 121° C. for 15 minutes. Autoclaving results in negligible minimal changes in the flavor produced. Sterilisation prevents contamination of the culture with other microorganisms, such as bacteria or other fungi, which may have been introduced into the culture liquid, particularly with the part of the plant. In another preferred embodiment, the culture liquid is already provided in sterile form.

In a preferred embodiment, for step (b), the mycelium and the culture liquid are combined in a ratio of 1:5 to 1:20, more preferably 1:10. For example, at a ratio of 1:10, 10 ml of mycelium is added to 100 ml of culture liquid. In this case, the total volume of the culture is 110 ml. With this ratio of mycelium and culture liquid, the formation of the savory flavor proceeds particularly well.

In a preferred embodiment, step (b) is carried out at a temperature of from 21° C. to 27° C., more preferably from 22° C. to 26° C., more preferably from 23° C. to 25° C., the most preferred temperature being 24° C. The temperature for cultivating the mycelium in the culture liquid (cultivation temperature) should be selected in such a manner that the mycelium has sufficient metabolic activity. For the mycelium of basidiomycetes, especially basidiomycetes of the class Agaricomycetes, a cultivation temperature of 21° C. to 27° C. is particularly suitable. The optimal cultivation temperature is 24° C.

In a preferred embodiment, the cultivation duration is from 5 to 103 hours, more preferably from 5 to 93 hours, more preferably from 5 to 77 hours.

The optimal cultivation duration depends on the basidiomycete, the part of the plant and the cultivation conditions.

In a preferred embodiment, step (b) is carried out until the desired flavor is achieved. The achievement of the desired flavor can be determined by the olfactory impression of the culture liquid. In this manner, a suitable cultivation duration can be determined for each constellation.

When the part of the plant is the clove of a garlic plant and the basidiomycete is Laetiporus sulphureus, the cultivation duration at a temperature of 21° C. to 27° C. is preferably from 41 to 86 hours, more preferably from 46 to 86 hours, more preferably from 60 to 86 hours, more preferably from 65 to 81 hours, more preferably from 70 to 76 hours, most preferably 76 hours. With a cultivation duration of 41 to 86 hours, a savory flavor of salami is produced.

When the part of the plant is the clove of a garlic plant and the basidiomycete is Polyporus umbellatus, the cultivation duration at a temperature of 21° C. to 27° C. is preferably from 5 to 34 hours or from 60 to 86 hours, more preferably from 5 to 29 hours or from 65 to 81 hours, more preferably from 70 to 76 hours, most preferably 76 hours. With a cultivation duration of 5 to 34 hours, a savory flavor is produced. With a cultivation duration of 60 to 86 hours, a savory meat flavor is produced.

When the part of the plant is the clove of a garlic plant and the basidiomycete is Pycnoporus cinnabarinus, the cultivation duration at a temperature of 21° C. to 27° C. is preferably from 18 to 73 hours, more preferably from 23 to 70 hours, more preferably from 26 to 49 hours, more preferably from 29 to 46 hours, most preferably 29 hours. With a cultivation duration of 18 to 73 hours, a savory flavor is produced. With a cultivation duration of 26 to 49 hours, a savory sausage flavor is produced.

When the part of the plant is the clove of a garlic plant and the basidiomycete is Pleurotus ostreatus, the cultivation duration at a temperature of 21° C. to 27° C. is preferably from 5 to 86 hours, more preferably from 18 to 86 hours, more preferably from 23 to 86 hours, more preferably from 60 to 86 hours, more preferably from 65 to 81 hours, more preferably from 70 to 76 hours, most preferably 70 hours. With a cultivation duration of 5 to 86 hours, a savory flavor is produced. With a cultivation duration of 18 to 86 hours, a savory sausage flavor is produced.

When the part of the plant is the clove of a garlic plant and the basidiomycete is Pleurotus sapidus, the cultivation duration at a temperature of 21° C. to 27° C. is preferably from 50 to 86 hours, more preferably from 50 to 81 hours, more preferably from 53 to 76 hours. With a cultivation duration of 50 to 86 hours, a savory flavor is produced.

When the part of the plant is the clove of a garlic plant and the basidiomycete is Trametes versicolor, the cultivation duration at a temperature from 21° C. to 27° C. is preferably from 41 to 58 hours, more preferably from 46 to 53 hours. With a cultivation duration of 41 to 58 hours, a savory flavor is produced.

When the part of the plant is the bulb from an onion plant and the basidiomycete is Laetiporus sulphureus, the cultivation duration at a temperature of 21° C. to 27° C. is preferably from 16 to 73 hours, more preferably from 21 to 69 hours, more preferably from 25 to 60 hours, more preferably from 29 to 53 hours, more preferably from 40 to 50 hours, most preferably 45 hours. With a cultivation duration of 16 to 73 hours, a savory meat flavor is produced. With a cultivation duration of 40 to 50 hours, a savory sausage flavor is also produced.

When the part of the plant is the bulb from an onion plant and the basidiomycete is Polyporus umbellatus, the cultivation duration at a temperature of 21° C. to 27° C. is preferably from 5 to 103 hours, more preferably from 5 to 93 hours, more preferably from 25 to 77 hours, more preferably from 25 to 50 hours or from 61 to 73 hours, more preferably from 29 to 45 hours or 69 hours, most preferably 69 hours. With a cultivation duration of 5 to 103 hours, a savory meat flavor is produced. With a cultivation duration of 25 to 50 hours and 61 to 73 hours, the savory meat flavor is a flavor of cooked meat.

When the part of the plant is the bulb from an onion plant and the basidiomycete is Pycnoporus cinnabarinus, the cultivation duration at a temperature of 21° C. to 27° C. is preferably from 5 to 12 hours, more preferably from 5 to 10 hours, most preferably 5 hours. With a cultivation duration of 5 to 12 hours, a savory flavor of bacon is produced.

When the part of the plant is the bulb from an onion plant and the basidiomycete is Pleurotus ostreatus, the cultivation duration at a temperature of from 21° C. to 27° C. is preferably from 25 to 49 hours or from 61 to 85 hours, more preferably from 29 to 45 hours or from 69 to 77 hours, most preferably 69 hours. With a cultivation duration of 25 to 49 hours as well as 61 to 85 hours, a savory sausage flavor is produced.

When the part of the plant is the bulb from an onion plant and the basidiomycete is Lentinula edodes, the cultivation duration at a temperature of 21° C. to 27° C. is preferably from 38 to 103 hours, more preferably from 40 to 98 hours, more preferably from 45 to 93 hours. With a cultivation duration of 38 to 103 hours, a savory meat flavor is produced.

When the part of the plant is the bulb from an onion plant and the basidiomycete is Lepista nuda, the cultivation duration at a temperature of 21° C. to 27° C. is preferably from 38 to 61 hours, more preferably from 40 to 58 hours, more preferably from 45 to 53 hours. With a cultivation duration of 38 to 61 hours, a savory sausage flavor is produced.

The preferred cultivation durations are the cultivation durations at which the best result in terms of the resulting savory flavor was observed in each case.

In a preferred embodiment, step (b) is carried out with shaking or stirring. Shaking or stirring the culture improves the introduction of oxygen into the culture liquid. Shaking or stirring also causes a constant mixing of the mycelium with the part of the plant in the culture liquid. This mixing makes it easier for the basidiomycete to produce the savory flavor. In addition, shaking or stirring the culture can prevent mycelium from depositing on the walls of the culture vessel. Shaking is done, for example, by incubating the culture on a rotary shaker.

Shaking or stirring is typically done at 100 to 200 rpm. Shaking or stirring is preferably done at 150 rpm. At this rate, good oxygenation of the culture liquid and good mixing of the mycelium with the part of the plant are achieved. In addition, no mycelial deposits occur on the walls of the culture vessel.

In a preferred embodiment, step (c) is carried out by filtration, preferably by vacuum filtration. Filtration, especially vacuum filtration, allows the culture liquid to be separated particularly quickly and easily from the mycelium and the part of the plant. The resulting solution is a clear, homogeneous filtrate.

In a preferred embodiment, the method further comprises:
(d) processing the solution which has the savory flavor.

The solution which has the savory flavor can be used directly as a flavoring. However, before using the flavor, the solution can be processed in a variety of ways according to methods known per se. The way of processing the solution depends mainly on the planned use of the savory flavor.

In a preferred embodiment, step (d) comprises concentrating the solution and/or spray drying the solution.

In a preferred embodiment, step (d) comprises extracting the flavor. In this way, a flavor extract can be obtained that is suitable, for example, for flavoring foodstuffs or for chromatographic analysis of the flavor.

For example, to extract the flavor, the flavor can first be adsorbed onto a suitable carrier material such as polydimethylsiloxane. The flavor is then eluted from the carrier material or thermally desorbed.

Extracting the flavor can be done, for example, by means of a sorbent-coated stir bar that extracts organic components from a sample while mixing the sample. An example of a suitable sorbent (extraction medium) is polydimethylsiloxane. Extracting the flavor by means of the sorbent-coated stir bar is particularly suitable for working up the solution for analytical examination of the flavor. For this purpose, it is sufficient to extract small amounts of the flavoring substances from the solution.

In another example, extracting the flavor may be done by means of an organic solvent or solvent mixture. An example of a suitable organic solvent is hexane. Other examples of suitable organic solvents are ethanol/methanol and dichloromethane. Examples of suitable solvent mixtures are dichloromethane:pentane (for example, in a ratio of 1:1.5) or pentane:diethyl ether (for example in a ratio of 1:1.12). Extracting the flavor by means of the solvent or solvent mixture is suitable both for analytical examination of the flavor and for further use of the flavor extract, in particular further use for flavoring foodstuffs. For further use in flavoring foodstuffs, food-grade solvents and/or fully removable solvents are preferred.

In another example, extracting the flavor can be done by means of a simple distillation for separating the water.

In a preferred embodiment, step (a) comprises:
(a1) cultivating the mycelium on a solid nutrient medium,
(a2) cultivating the mycelium obtained in step (a1) in a liquid nutrient medium, and
(a3) washing of the mycelium obtained in step (a2).

The solid nutrient medium is typically an agar plate, i.e. a plate containing agar-agar. The solid nutrient medium is, for example, an agar plate with malt extract medium. For example, the agar plate may contain 2% malt extract and 1.5% agar-agar. Cultivating the mycelium on the solid nutrient medium takes place for several days, for example, for 7 to 14 days. The duration depends, among other things, on the basidiomycete. For Laetiporus sulphureus and Pycnoporus cinnabarinus, a duration of 14 days is preferred. For Polyporus umbellatus and Pleurotus ostreatus, a duration of 7 days is preferred. For Pleurotus sapidus, Trametes versicolor, Lentinula edodes and Lepista nuda, a duration of 7 days is also preferred.

Cultivating the mycelium obtained in step (a1) in the liquid nutrient medium (step (a2)) is referred to as preculture, while cultivating the mycelium in the culture liquid in step (b) of the method according to the invention is referred to as main culture. The liquid nutrient medium of the preculture is, for example, a malt extract medium. The liquid nutrient medium may contain, for example, 2% malt extract. Cultivating the mycelium in the liquid nutrient medium takes place for several days, for example, for 7 days. Due to the preculture a higher density of the mycelium and higher intensities of the flavors compared to a cultivation in the culture liquid without a preculture are achieved. In addition, by means of the preculture, any growth abnormalities of the mycelium and/or contaminations can be detected at an early stage, so that corresponding precultures are not used for a main culture.

Steps (a1) and (a2) are preferably carried out at a temperature of 21° C. to 27° C., a temperature of 24° C. being particularly preferred.

Washing of the mycelium obtained in step (a2) is preferably done in sterile distilled water and serves to free the mycelium from the nutrient medium of the preculture.

The washed mycelium is placed in the culture liquid for step (b). This step is also referred to as “over-inoculating” the mycelium or “inoculating” the main culture.

In another embodiment, step (a) comprises cultivating the mycelium on a solid substrate plate. The substrate plate is typically an agar plate containing the substrate (that is, the garlic clove or the onion) but no culture medium (such as malt extract medium). In this case, the mycelium can be transferred directly from the substrate plate into the culture liquid and a preculture is not necessary. Cultivating the mycelium on the substrate plate is preferably carried out at a temperature of 21° C. to 27° C., with a temperature of 24° C. being particularly preferred.

In a second aspect, the invention relates to a solution which has a savory flavor obtainable by a method according to the invention.

In a third aspect, the invention relates to a use of the solution according to the invention for flavoring foodstuffs.

The foodstuffs can be liquid or solid foodstuffs. The foodstuffs are preferably vegetarian or vegan meat or sausage substitutes. Vegetarian or vegan meat or sausage substitutes are often based on seitan, grains, legumes and/or soy. By using the solution according to the invention, a savory flavor, in particular a meat or sausage flavor, can be imparted to the products.

In addition to submerged cultivation, surface cultivation of certain basidiomycetes can also be used to produce a savory flavor.

Disclosed therefore is a method for preparing a culture plate which has a savory flavor, the method comprising the following steps:
(a) providing a mycelium of a basidiomycete, and
(b) cultivating the mycelium on a culture plate for a cultivation duration of 10 to 20 days, the culture plate containing at least a part of a plant of the genus Allium L, wherein cultivating the mycelium results in a savory flavor in the culture plate, wherein the part of the plant is a clove of a garlic plant and the basidiomycete is Laetiporus sulphureus, Polyporus umbellatus, Pycnoporus cinnabarinus, Pleurotus ostreatus, Trametes versicolor and/or Lepista nuda.

The mycelium is cultivated on the culture plate. The cultivation is a typical surface cultivation. The cultivation is preferably carried out at a temperature of 21° C. to 27° C., with a temperature of 24° C. being particularly preferred.

The culture plate is preferably an agar plate, i.e. a plate containing agar-agar. In a particularly preferred embodiment, the agar plate consists of the clove of the garlic plant, agar-agar and water, wherein the clove of the garlic plant is in a minced form.

The optimal cultivation duration of surface cultivation depends on the cultivation conditions and the basidiomycete. For Laetiporus sulphureus, Polyporus umbellatus, Pleurotus ostreatus and Trametes versicolor, a cultivation duration of 10 days at a temperature of 21° C. to 27° C. is preferred. For Pycnoporus cinnabarinus, a cultivation duration of 12 days at a temperature of 21° C. to 27° C. is preferred. For Lepista nuda, a cultivation duration of 18 days at a temperature of 21° C. to 27° C. is preferred.

A suitable cultivation duration can be determined by the olfactory impression of the culture plate.

The basidiomycetes that can be used for the method for preparing a culture plate are basidiomycetes that are edible for humans.

The part of the plant preferably has a proportion of from 0.5% by weight to 5% by weight, more preferably from 1% by weight to 5% by weight, more preferably 1% by weight, based on the total weight of the culture plate. At 1% by weight, this means that the part of the plant in the culture plate has a concentration of 10 g/L.

The flavor is preferably a meat flavor and/or a sausage flavor. Here, the sausage flavor is preferably a flavor of sausages.

The flavor is preferably an odor. Compared to submerged cultivation, the intensity of the odor obtained is lower in surface cultivation.

The method of preparing a culture plate preferably further comprises extracting the flavor from the culture plate. The flavor can be used, for example, for flavoring foodstuffs.

### EXAMPLES

### Example 1: Identification of Substrates and Basidiomycetes for the Production of Savory Flavors

For evaluating the ability of edible basidiomycetes to produce pleasant natural flavors by cultivating parts of plants of the genus Allium L., especially garlic, various edible basidiomycetes were first selected and then cultivated in surface cultivation (on agar plates) and in submerged cultivation (in an aqueous culture liquid). The cultivated samples were sensory evaluated by experienced staff of the Department of Flavor Chemistry of the University of Hohenheim (Germany). Flavor changes were monitored by means of gas chromatography-mass spectrometry-olfactometry (GC-MS-O) in combination with “stir-bar-sorptive-extraction” (from “stir bar”, magnetic stir bar, and “sorptive extraction”, sorption extraction; abbreviated SBSE).

First, various edible basidiomycetes (19 species) and one ascomycete were selected. The fungal strains to be tested were selected based on experience from previous projects. Fungal strains already known for their high consumer acceptance in Europe and their economic importance in the food sector were prioritised. A suitable sample preparation method (autoclaving, 15 min, 121° C.) was defined.

By surface cultivation (agar plate containing 10 g/L of minced garlic clove (garlic agar plate)), the fungal strains were tested for their ability to grow on garlic cloves as a substrate. The growth characteristics were recorded. Fully vegetated surface cultures were evaluated sensory.

Basidiomycetes that grew well on the substrate and already provided interesting flavors in surface cultivation were selected for submerged cultivation.

For submerged cultivating, the fungal strains were cultivated in liquid garlic medium (20 g/L minced garlic clove in distilled water) or in liquid onion medium (20 g/L minced yellow edible onion in distilled water). During cultivation, samples of the culture liquid were taken every 4 to 12 hours for 5 days and evaluated sensory after separation of the mycelium and the garlic clove or onion. The description of odor attributes and intensity was given in comparison to a medium without fungal strains. Intensity (1) was rated using a single-point scale from 0 to 5, wherein 0 means imperceptible, 1 means very weak, 2 means weak, 3 means moderate, 4 means strong, and 5 means very strong. If the odor of a sample was perceived as pleasant, the taste of the sample was additionally described by “sip-and-spit-out” (take a sip and spit it out).

Samples of the submerged cultures with interesting flavors were analysed by GC-MS-O.

### Materials and Methods

### Preparation:

The peeled, frozen garlic clove (stored at −20° C., provided by Raps GmbH & Co. KG, Kulmbach, Germany) was thawed and mechanically crushed with a knife. The onions were obtained from the supermarket and used directly for cultivation. For this, the onions were peeled and cut into fine cubes (about 5×5 mm). In the appropriate composition (10 g/L garlic clove with 15 g/L agar-agar in distilled water for surface cultivation; 20 g/L garlic clove or onion in distilled water for submerged cultivation), the medium was autoclaved (15 min, 121° C.).

### Surface Cultivation:

The fungal strains were first grown on media plates with original medium (malt extract (ME), malt extract peptone (MEP), or standard nutrient solution (SNL)). Once the plates were fully overgrown, a 1 cm² piece was cut from the outer edge of the plate and transmitted to the garlic agar plate. The plates were cultivated at 24° C. in the dark. The growth of the fungi was measured every 3rd or 4th day. The odor of the plates was evaluated when the fungal mycelium had reached a radius of >4 cm.

### Submerged Cultivation and Sensory Evaluation:

Fungal strains of interest from surface cultivation were selected for submerged cultivation. 100 mL of garlic or onion medium (20 g/L of crushed garlic clove or 20 g/L of diced onion in distilled water) was transferred to a 250 mL Erlenmeyer flask (flask) and autoclaved. The fungal strains were first grown on media plates with original medium at 24° C. in the dark as for surface cultivation. Subsequently, the fungal strains were transferred to a preculture with liquid original medium. After preculturing for one week on a rotary shaker (150 rpm) at 24° C. in the dark, the mycelium was washed in sterile water, homogenized in 10 mL of sterile water (10 sec, 10000 rpm), and added to the garlic or onion medium (culture liquid). The cultures (main cultures) were incubated for 6 days on a rotary shaker (24° C., 150 rpm, in the dark). Above the culture liquid, there was oxygen in the headspace of the flasks, which was partially introduced into the culture liquid by the shaking movement. The plugs of the flasks were air-permeable. Samples were taken every 4 to 12 hours: 5 mL of culture liquid was removed from the flask and centrifuged for 10 min (2150 g, 22° C.). The supernatant was transferred to 20 mL glass vials and incubated for at least 10 min at room temperature. Subsequently, the samples were evaluated sensory. In the process, the perceived odor was described. If the odor of a sample was perceived as pleasant, the taste of the sample was additionally described by “sip-and-spit-out” (take a sip and spit it out).

### Gas Chromatography Analysis:

For SBSE analysis, 10 mL of the culture liquid was added to a 20 mL glass vial. A 10 mm Twister® with 0.5 mm polydimethylsiloxane (PDMS) coating was added to the culture liquid and the flavoring substances were extracted for 2 hours at room temperature while stirring (1000 rpm). The extracted flavoring substances were thermally desorbed (220° C.) and added to the gas chromatography system.

### Results

### Surface Cultivation:

Table 1 shows the olfactory impressions as well as the intensity (1) of the olfactory impressions of the garlic agar plates when the fungal mycelium had reached a radius of >4 cm (=cultivation duration). For intensity, 0 means imperceptible, 1 very weak, 2 weak, 3 moderate, 4 strong, 5 very strong.

TABLE 1

| | Original | Cultivation | Olfactory impression |
|---|---|---|---|
| Fungal species | medium | duration [d] | of the garlic agar plate |
| Negative control | — | — | garlic, bread, roasted |
| (without mycelium) | | | (I = 2) |
| Agaricus arvensis (AAR) | ME | 31 | garlic, fungus (I = 2) |
| Agaricus campestris (ACA) | SNL | 25 | old sausage (I = 1) |
| Agrocybe aegerita (AAE) | ME | 10 | garlic, plastic, woody |
| | | | (I = 1) |
| Flammulina velutipes (FVE) | ME | 10 | garlic, parsley (I = 2) |
| Ganoderma lucidum (GLU) | MEP | 31 | garlic, carton (I = 2) |
| Ischnoderma benzoinum (IBE) | MEP | 17 | garlic, marzipan, almond |
| | | | (I = 2) |
| Laetiporus sulphureus (LSU) | ME | 10 | garlic, salami, fungus |
| | | | (I = 3) |
| Lepista nuda (LNU) | ME | 18 | garlic, meat (I = 3) |
| Lentinula edodes (LED) | ME | 13 | garlic, almond, spicy |
| | | | (I = 2) |
| Lycoperdom pyriforme (LPY) | MEP | 25 | old garlic, agar (I = 1) |
| Mortiella isabellina* (MIS) | MEP | 20 | garlic, sausages (I = 2) |
| Mycetinis scorodonius (MSC) | ME | 18 | garlic, straw, latex |
| | | | (I = 1) |
| Pholiota nameko (PNA) | ME | 10 | garlic, chemical (I = 1) |
| Pleurotus eryngii (PER) | ME | 10 | garlic, bread, sweetish |
| | | | (I = 1) |
| Pleurotus ostreatus (POS) | ME | 10 | garlic, meat, licorice |
| | | | (I = 2) |
| Pleurotus sapidus (PSA) | ME | 10 | garlic, vanilla, woody |
| | | | (I = 2) |
| Polyporus umbellatus (PUM) | ME | 10 | garlic, meat, parsley |
| | | | (I = 2) |
| Pycnoporus cinnabarinus (PCI) | ME | 12 | garlic, spicy, meat |
| | | | (I = 2) |
| Trametes versicolor (TVE) | ME | 10 | garlic, sausages, bread |
| | | | (I = 2) |
| Wolfiporia cocos (WCO) | ME | 17 | garlic, floral, citrus |
| | | | (I = 3) |

*Ascomycete (not a basidiomycete)

### Submerged Cultivation:

Tables 2 and 3 show the olfactory impressions as well as the intensity (I) of the olfactory impressions of the samples of the submerged cultures for the garlic medium. The meaning of the abbreviations for the fungal species can be seen in Table 1. For intensity, 0 means imperceptible, 1 very weak, 2 weak, 3 moderate, 4 strong, 5 very strong. The best results are shown in bold. The best results were defined as those samples that had an interesting, appealing flavor (smell and taste) as well as a high intensity.

TABLE 2

| Cultivation | | | | |
|---|---|---|---|---|
| duration | | | | |
| (h) | PSA | PUM | TVE | LED |
| 0 | garlic, bread | garlic, bread | garlic, bread | garlic, bread |
| (without | (I = 3) | (I = 3) | (I = 3) | (I = 3) |
| mycelium) | | | | |
| 5 | garlic, bread | garlic, bread, | garlic, bread | garlic, bread |
| | (I = 2) | savory | (I = 2) | (I = 1) |
| | | (I = 3) | | |
| 23 | garlic, bread, | garlic, bread, | garlic, spicy, | garlic, bread |
| | flat (I = 2) | savory | sweetish | (I = 1) |
| | | (I = 3) | (I = 1) | |
| 29 | garlic, bread, | garlic, bread, | garlic, spicy, | garlic, bread |
| | flat (I = 2) | savory | sweetish | (I = 1) |
| | | (I = 1) | (I = 1) | |
| 46 | garlic, bread, | odorless | garlic, spicy, | garlic, bread |
| | nutty (I = 2) | (I = 0) | savory | (I = 1) |
| | | | (I = 1) | |
| 53 | bread, hearty, | odorless | garlic, spicy, | bread, burnt |
| | nutty (I = 2) | (I = 0) | savory | (I = 1) |
| | | | (I = 2) | |
| 70 | bread, hearty, | garlic, meaty | garlic, nutty | bread, burnt |
| | nutty (I = 2) | (I = 2) | (I = 3) | (I = 1) |
| 76 | bread, hearty, | garlic, meaty | garlic, nutty | bread, pungent |
| | nutty (I = 2) | (I = 2) | (I = 2) | (I = 1) |
| 143 | urine (I = 2) | nutty, urine | urine | bread, urine |
| | | (I = 2) | (I = 2) | (I = 1) |

TABLE 3

| Cultivation | | | | | |
|---|---|---|---|---|---|
| duration | | | | | |
| (h) | POS | IBE | LSU | WCO | PCI |
| 0 | garlic, bread | garlic, bread | garlic, bread | garlic, bread | garlic, bread |
| (without | (I = 3) | (I = 3) | (I = 3) | (I = 3) | (I = 3) |
| mycelium) | | | | | |
| 5 | garlic, bread, | garlic, coconut | garlic, bread | garlic, bread | garlic, bread |
| | savory | (I = 1) | (I = 2) | (I = 2) | (I = 2) |
| | (I = 3) | | | | |
| 23 | garlic, sausage, | garlic, nutty | garlic, old | garlic, bread, | garlic, savory |
| | nutty (I = 2) | (I = 1) | bread, carton | sweetish | (I = 2) |
| | | | (I = 2) | (I = 2) | |
| 29 | garlic, sausage, | garlic, nutty | garlic, old | bread, sweetish, | garlic, sausage |
| | nutty (I = 2) | (I = 1) | bread, carton | biscuit | (I = 3) |
| | | | (I = 2) | (I = 2) | |
| 46 | garlic, sausage, | nutty, carton | garlic, salami, | bread, nutty | garlic, sausage |
| | sweetish | (I = 1) | flat (I = 2) | (I = 1) | (I = 2) |
| | (I = 2) | | | | |
| 53 | garlic, sausage, | nutty, carton | garlic, salami, | bread, nutty | savory |
| | sweetish | (I = 1) | flat (I = 3) | (I = 1) | (I = 2) |
| | (I = 2) | | | | |
| 70 | sausage, savory | nutty, oily | garlic, salami | bread, nutty | savory, nutty |
| | (I = 2) | (I = 1) | (I = 3) | (I = 1) | (I = 1) |
| 76 | sausage, savory | nutty, oily | garlic, salami | bread, nutty | nutty |
| | (I = 2) | (I = 1) | (I = 4) | (I = 1) | (I = 1) |
| 143 | urine (I = 2) | — | — | — | — |

Table 4 shows the olfactory impressions of the samples of the submerged cultures for the onion medium. The meaning of the abbreviations for the fungal species can be seen in Table 1. The best results are shown in bold. The best results were defined as those samples that had an interesting, appealing flavor (smell and taste) as well as a high intensity.

The olfactory impression “green” is a defined olfactory impression in sensory perception. This describes flavors that have an odor reminiscent of grass/leaves/green vegetables (for example, cucumber, lettuce).

TABLE 4

| Cultivation | | | | | | | |
|---|---|---|---|---|---|---|---|
| duration | | | | | | | |
| (h) | PUM | TVE | LED | POS | LSU | LNU | PCI |
| 0 (without | onion, roasted, | onion, roasted, | onion, roasted, | onion, roasted, | onion, roasted, | onion, roasted, | onion, roasted, |
| mycelium) | sweetish (I = 3) | sweetish (I = 3) | sweetish (I = 3) | sweetish (I = 3) | sweetish (I = 3) | sweetish (I = 3) | sweetish (I = 3) |
| 5 | onion, meat | onion, roasted, | onion, sweetish | onion, vinegar | onion, roasted, | onion, carton | onion, roasted, |
| | (I = 2) | sweetish (I = 2) | (I = 3) | (I = 2) | sweetish (I = 2) | (I = 1) | bacon (I = 2) |
| 21 | meat, liver | green, eucalyptus | odorless (I = 0) | onion, yeast | onion, meat, | onion, sweetish | stinky, pungent, |
| | (I = 2) | (I = 2) | | (I = 2) | sourish (I = 1) | (I = 1) | mould (I = 3) |
| 29 | cooked meat | eucalyptus | odorless (I = 0) | yeast, sausage | onion, meat | onion, moss | pungent, chemical |
| | (I = 1) | (I = 2) | | (I = 2) | (I = 2) | (I = 1) | (I = 3) |
| 45 | cooked meat, | fungus, green | meat (I = 1) | sausage, green | onion, meat, | moss, sausage | chemical, mould |
| | liver (I = 1) | (I = 2) | | (I = 2) | sausage (I = 3) | (I = 1) | (I = 3) |
| 53 | meat, liver | fungus, green | meat (I = 1) | green, spicy | onion, meat | sausage, oily | mould, earthy, |
| | (I = 1) | (I = 2) | | (I = 2) | (I = 3) | (I = 1) | beetroot (I = 3) |
| 69 | cooked meat | fungus (I = 2) | meat (I = 1) | spicy, sausage | meat, carton | oily, petroleum | earthy, fungus |
| | (I = 2) | | | (I = 2) | (I = 2) | (I = 1) | (I = 3) |
| 77 | meat (I = 2) | fungus, pungent | meat, corn | spicy, sausage, | stinky, urine | oily, petroleum | earthy, fungus |
| | | (I = 2) | (I = 1) | vinegar (I = 2) | (I = 2) | (I = 1) | (I = 3) |
| 93 | meat, vinegar | fungus, yeast | meat, corn | yeast (I = 1) | liver, stinky, | oily, nutty | earthy, fungus, |
| | (I = 2) | (I = 2) | (I = 1) | | sourish (I = 3) | (I = 1) | yeast (I = 3) |

The flavor of the autoclaved culture liquid was stable for the entire PG-5T duration of the experiment in the negative control (control without fungal mycelium) that was also carried out. Especially in the first 3 days of cultivation, the flavor of the negative control hardly changed. Only after 143 hours of cultivation, old or flat olfactory impressions could be perceived in the negative control. For the garlic medium, the flavor of the autoclaved culture liquid could be described as “garlic-like, bread-like, roasted”, and for the onion medium as “onion-like, roasted, sweetish”.

If the odor of a sample of a submerged culture was perceived as pleasant or desirable, the taste of the sample was additionally examined by “sip-and-spit-out”. Here, the odor corresponded very well to the taste and the overall flavor of the samples, respectively. In particular, in the samples with a meat-like and/or sausage-like smell, an intense meat-like or sausage-like taste flavor could also be perceived.

The results of submerged cultivation have already been successfully reproduced in larger culture volumes, for example in culture volumes of 500 ml (in 1 L flasks).

### Gas Chromatography Analysis:

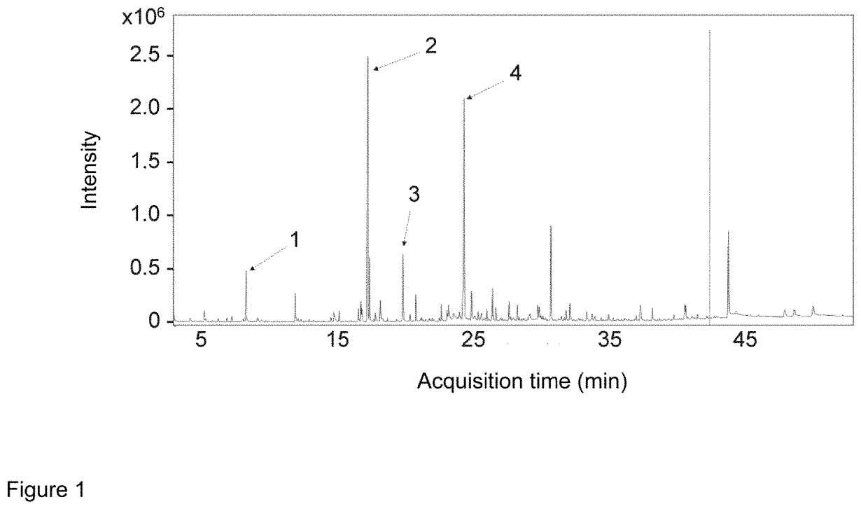

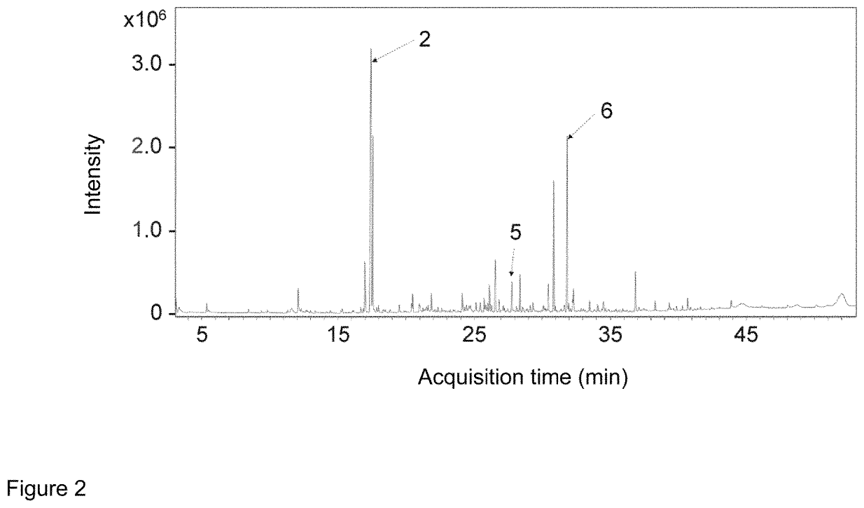

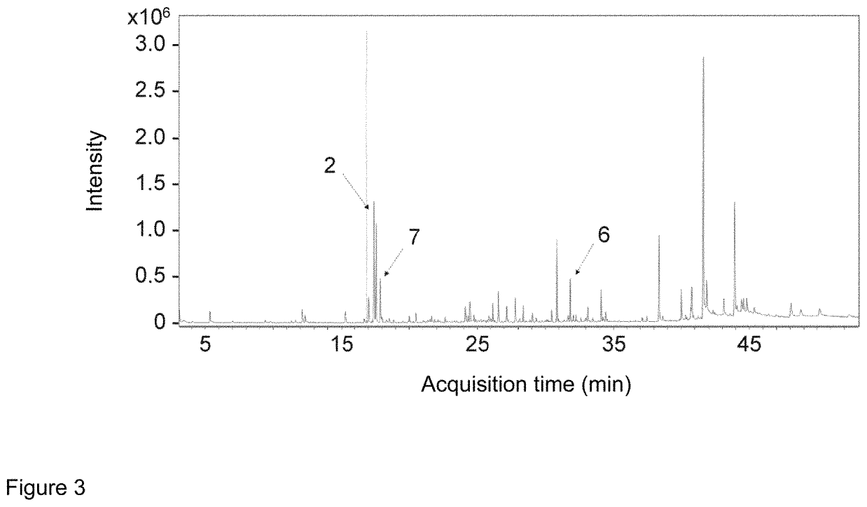

FIGS. 1 to 3 show gas chromatograms of extracted flavoring substances from samples of the culture liquid of the submerged culture in garlic medium. No mycelium was cultivated in the culture liquid (control without mycelium; FIG. 1), a mycelium of Laetiporus sulphureus was cultivated (FIG. 2) or a mycelium of Polyporus umbellatus was cultivated (FIG. 3).

The chromatograms show clearly discernible differences in the flavor profile of the samples. The compounds that are most noticeably different between samples based on the chromatograms (new peaks or change in the intensity of the peak) have already been partially identified. The compounds already identified are:
1: diallyl sulphide;
2: diallyl disulphide;
3: methyl propyl trisulphide;
4: allyl trisulphide;
5: benzothiazole;
6: eugenol, and
7: 5-sec-butyl-2,3-dimethylpyrazine.

### Example 2: Identification of Flavor-Active Compounds

A sample of the culture liquid of a submerged culture of Laetiporus sulphureus in garlic medium as described in Example 1 was analysed for flavor-active compounds by “direct immersion-stir bar sorptive extraction” (DI-SBSE) in combination with gas chromatography-mass spectrometry-olfactometry. Compounds were identified by olfactory impression and mass spectra.

Table 5 shows the compounds that have been identified so far.

TABLE 5

| Olfactory impression | Identified compound |
|---|---|
| fermented, garlic-like | diallyl sulphide* |
| salami-like, garlic-like | Methyl-2-propenyl disulphide* |
| vinegar-like | acetic acid |
| onion-like, sulphurous | (Z)-1-Allyl-2-(prop-1-en-1-yl)disulphane* |
| caramel-like, yeasty | furfural |
| garlic-like | diallyl disulphide* |
| garlic-like | (E)-1-Allyl-2-(prop-1-en-1-yl)disulphane* |
| onion-like, green | decanal* |
| almond-like | benzaldehyde |
| garlic-like | Methyl 2-propenyl trisulphide* |
| garlic-like | 1-Methyl-2-pyrrolidinone |
| like cooked meat | 2-Hexadecanol |
| meat-like, fermented | γ-Crotonolactone |
| roasted, meat-like | 2-Hydroxy-2-cyclopenten-1-one |
| garlic-like | Di-2-propenyl trisulphide* |
| floral, roasted | furfuryl acetone |
| sweetish, sulphurous | benzothiazole* |

Several sulphur-containing flavoring substances that have already been described from garlic (marked with *) could be identified.

The flavor of a foodstuff is very complex and is composed of a variety of flavoring substances. Typically, an overall flavor is composed of 10 to 15 flavoring substances from a wide variety of odors, which then interact to form the typical odor. The inventors also assume for their sample that the overall flavor is not defined by a single compound, but that the interaction of the identified flavoring substances leads to the typical salami-like odor. This means that even if one compound was perceived as “salami-like”, this does not mean that this compound is the only one responsible for the overall flavor of the sample.

In comparison with commercially available salami, the inventors were able to obtain hardly any matches in the flavoring substance profile. Nevertheless, the sample and the commercially available salami showed similar flavors.

### Example 3: Cultivation Under UV Light

To investigate the influence of UV light, a parallel cultivation with and without UV light was carried out for the submerged culture of Laetiporus sulphureus in garlic medium for a cultivation duration of 76 h. After cultivation, samples of the culture liquid were subjected to sensory and analytical analysis.

By smelling the samples, it could be determined that the two samples (cultivation with/without UV light) differed in overall flavor. The sample of cultivation without UV light showed the typical salami-like flavor. In contrast, the sample from the cultivation with UV light had a savory, garlic-like odor, but hardly any typical salami notes. Instrumental analysis also revealed some differences in the flavor profile of the two samples (data not shown).

### Example 4 (not According to the Invention): Testing of Further Plants or Further Parts of Plants of the Genus Allium L. As Substrates

Chives, leeks, spring onions, garlic peels and onion peels (yellow kitchen onion) were selected as further substrates. These other substrates were tested with the following basidiomycetes: Laetiporus sulphureus, Polyporus umbellatus and Pleurotus ostreatus. The cultivation of the basidiomycetes was carried out as described in Example 1 for garlic cloves and onions.

By smelling samples of the culture liquids, it was determined that no savory flavors were produced in the cultures of Laetiporus sulphureus, Polyporus umbellatus, and Pleurotus ostreatus with the other substrates.

1. A method for preparing a solution which has a savory flavor, the method comprising the following steps:
(a) providing a mycelium of a basidiomycete,
(b) cultivating the mycelium in an aqueous culture liquid for a cultivation duration of 5 to 108 hours, wherein the culture liquid has at least a part of a plant of the genus Allium L., wherein by cultivating the mycelium a savory flavor is produced in the culture liquid, and
(c) separating the culture liquid from the mycelium and the part of the plant, as a result of which the solution which has the savory flavor is obtained,
wherein the part of the plant is a clove of a garlic plant and the basidiomycete is Laetiporus sulphureus, Polyporus umbellatus, Pycnoporus cinnabarinus, Pleurotus ostreatus, Pleurotus sapidus and/or Trametes versicolor, or
wherein the part of the plant is a bulb from an onion plant and the basidiomycete is Laetiporus sulphureus, Polyporus umbellatus, Pycnoporus cinnabarinus, Pleurotus ostreatus, Lentinula edodes and/or Lepista nuda.

2. The method according to claim 1, wherein the basidiomycete is Laetiporus sulphureus, Polyporus umbellatus, Pycnoporus cinnabarinus and/or Pleurotus ostreatus.

3. The method according to claim 1, wherein the savory flavor is a meat flavor and/or a sausage flavor.

4. The method according to claim 1, wherein the part of the plant is in a minced form, the minced form preferably being a pressed, chopped, ground or pureed form.

5. The method according to claim 1, wherein the culture liquid consists of water, preferably distilled water, and the part of the plant.

6. The method according to claim 1, wherein step (b) is carried out at a temperature of 21° C. to 27° C.

7. The method according to claim 1, wherein the cultivation duration is from 5 to 103 hours.

8. The method according to claim 1, wherein step (c) is carried out by filtration.

9. A solution which has a savory flavor obtainable by a method in accordance with claim 1.

10. A foodstuff comprising the solution according to claim 9.

11. The method according to claim 1, wherein step (b) is carried out at a temperature of 24° C.

12. The method according to claim 1, wherein the cultivation duration is from 5 to 93 hours.

13. The method according to claim 1, wherein the cultivation duration is from 5 to 77 hours.

14. The method according to claim 1, wherein step (c) is carried out by vacuum filtration.
